(19) United States
(12) Patent Application Publication
(10) Pub. No.: US 2009/0063467 A1
(43) Pub. Date: Mar. 5, 2009

(54) Persona management in a geo-spatial environment

(75) Inventor: Raj Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/897,903

(22) Filed: Aug. 30, 2007

(51) Int. Cl. G06F 7/06

(52) U.S. Cl. 707/5; 707/E17.018

(57) ABSTRACT

A method and system of persona management in a geo-spatial environment are disclosed. In one embodiment a method of a persona management includes creating a plurality of persona profiles associated with a first member of a community network, determining a plurality of locations associated with each of the persona profiles, displaying the persona profiles at the locations on a geo-spatial map, and managing the persona profiles using the geo-spatial map. The method may include accessing one of the persona profiles, determining a context of expression associated with the persona profiles, generating a communication between the persona profiles and/or a contact associated with the persona profiles based on the context of expression, and sending the communication to the contact using the community network.

### FIELD OF TECHNOLOGY

This disclosure relates generally to the technical fields of communications and, in one example embodiment, to a method and system of persona management in a geo-spatial environment.

### BACKGROUND

A user (e.g., a person) may communicate differently with different groups of people. For example, the user may communicate with his/her friends using an informal tone of expression (e.g., playful, unabashed, free-flowing, etc.) and switch to a formal tone of expression (e.g., deliberate, careful, focused, etc.) when communicating with his/her co-workers. These different communication styles may each reflect a persona of the user. The persona may be a social role played by the user when interacting in a specific context (e.g., may change according to situation, time, and/or location).

The user may communicate with the different groups of people through a variety of mechanisms (e.g., email, instant messaging, simple text messaging, voice, non-verbal expressions, etc.). Each mechanism may have a particular form in which communication occurs. For example, the user may communicate with his/her co-workers through a corporate email system (e.g., Microsoft® Outlook). On the other hand, the user may communicate with friends through a public free email provider (e.g., Google® Gmail), through a telephone (e.g., text messaging system and/or voice system) and/or through a social network (e.g., MySpace®, Friendster®, etc.).

A multitude of social roles of the user may result in role confusion. Role confusion may be a situation where the user has trouble determining which role he/she should play. For example, the user may be a college student who joins a group of a social interest (e.g., a Football group) in the social network and finds a professor who is also a member of the group. A conflict may emerge between the user's personas as a student and as an enthusiast (e.g., who shares a same interest as the professor), thus leading to confusion. The user may communicate with the professor through email in a formal, deferential tone when discussing college homework, but in an informal tone when discussing sports in the social network.

As such, the social role may be a set of expectations that society places on the user. By unspoken consensus, certain behaviors may be deemed “appropriate” and others “inappropriate”. The social role may be a set of actions associated with a particular status. In other words, “status” may be a state the user occupies, while “role” may be a set of expected behaviors attached to that state. The social role may be semi-permanent (e.g., “male”, “mother”, “child”, etc), or it may be transitory (e.g., “soccer player”, “political enthusiast”, “college student”, etc). In addition, the social role may be associated with one or more methods of communication (e.g., email, telephone, postal mail, etc.), one or more time periods of the user's life (e.g., childhood, adolescence, college, middle age, etc.), and/or one or more locations (e.g., hometown, college town, current residence, current work location, etc.).

When communication modalities become complex, it may become increasingly difficult for the user to draw associations of context when communicating with specific others. For example, the user may forget that a particular coworker, 5 years earlier, was known to the user during his/her college days as a classmate acquaintance. A loss of this context in relationships of the user, across time, may result in a loss of relationships and/or diminished social interactions as time progresses. In addition, role confusion may increase stress on the user and/or may sometimes result in embarrassing complexity in misguided communications of the user with other parties.

### SUMMARY

A method and system of persona management in a geo-spatial environment are disclosed. In one aspect, a method of persona management includes creating a plurality of persona profiles (e.g., may be associated with an email address) associated with a first member of a community network, determining a plurality of locations associated with each of the persona profiles, displaying the persona profiles at the locations on a geo-spatial map, and managing the persona profiles using the geo-spatial map.

The method may further include accessing one of the persona profiles, determining a context of expression associated with the persona profile (e.g., based on the first member's behavior, status, activities, and/or preferences in the persona profile and/or based on a relationship history between the first member and the contact), generating a communication between the persona profile (e.g., associated with a contact, a group, an endorsement, and/or an event, etc.) and a contact associated with the persona profile (e.g., may include a second member of the community network) based on the context of expression, and sending the communication to the contact using the community network.

In another aspect, a community network includes a member repository including a plurality of members, a geo-spatial repository including a plurality of locations on a geo-spatial map, a member management module configured to obtain member data (e.g., may include at least one of the locations) associated with each of the members, and a persona management module configured to obtain a plurality of persona profiles associated with a first of the members, determine the location associated with the persona profiles, display the persona profiles at the location on the geo-spatial map, and manage the persona profiles using the geo-spatial map.

The persona management module may further be configured to access one of the persona profiles (e.g., associated with an email address, a contact, a group, an endorsement, and/or an event, etc.), determine a context of expression associated with the persona profile (e.g., based on the first member's behavior, status, activities, and/or preferences in the persona profile and/or based on a relationship history between the first member and the contact), generate a communication between the persona profile and a contact associated with the persona profile (e.g., may include a second member) based on the context of expression, and send the communication to the contact. Each of the persona profiles may be associated with one of a plurality of content modules.

In yet another aspect, a method of persona management includes creating a persona profile (e.g., may be associated with a contact, a group, an endorsement, and an event) associated with a member of a community network, obtaining a location associated with the persona profile, obtaining at least one contact associated with the persona profile, determining a context of expression corresponding to the persona profile (e.g., based on a relationship history between the member and the contact), generating a communication between the member and the contact based on the context of expression, and sending the communication to the contact using the community network. The method may further include displaying the persona profile on a geo-spatial map. In addition, the method may include obtaining an email address associated with the persona profile.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community network enabling persona management in a geo-spatial environment, according to one embodiment.

FIG. 2A is a user interface view displaying persona profiles associated with a member on a geo-spatial map, according to one embodiment.

FIG. 2B is a user interface view of managing a persona profile using the geo-spatial map, according to one embodiment.

FIG. 2C is a user interface view of generating a communication between the persona profile and a contact associated with the persona profile based on a context of expression, according to one embodiment.

FIG. 3 is a block diagram illustrating persona profile details of a member in the community network, according to one embodiment.

FIG. 4 is a flowchart of managing persona profiles of the member and sending a communication, according to one embodiment.

FIG. 5 is a flow chart of displaying persona profiles of the member and sending a communication to a contact based on a context of expression, according to one embodiment.

FIG. 6 is a diagrammatic system view of a data processing system in which any of the embodiments disclosed herein may be performed, according to one embodiment.

FIG. 7 is a process flow of managing persona and sending a communication to a contact in a community network, according to one embodiment.

Other features of the present embodiments will be apparent from the accompanying drawings and from the detailed description that follows.

### DETAILED DESCRIPTION

A method and system of persona management in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

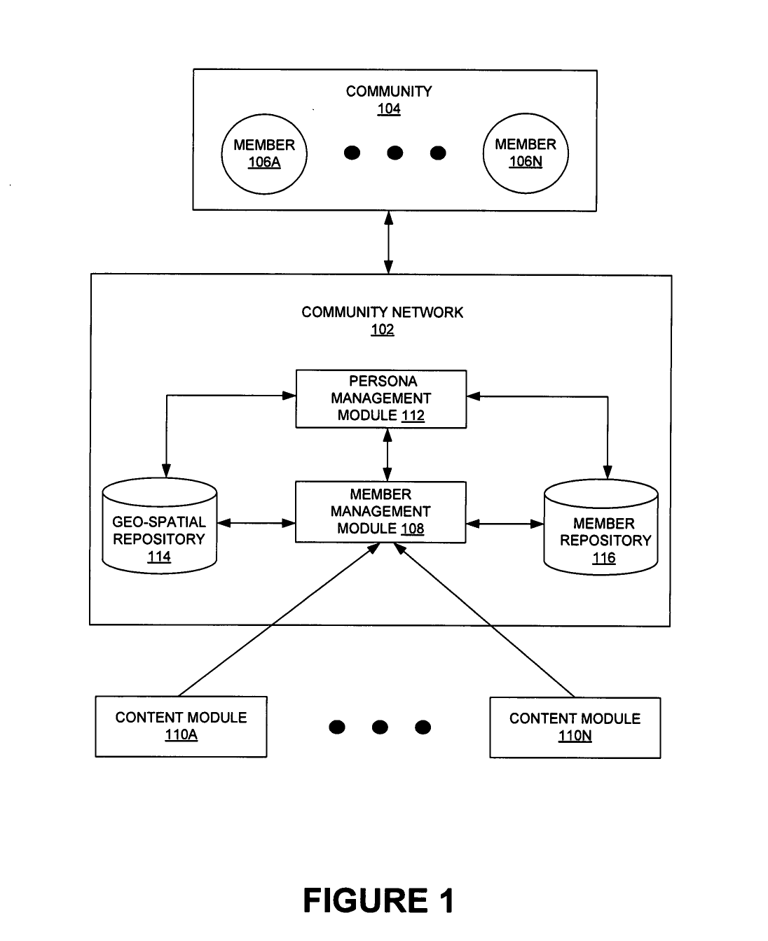

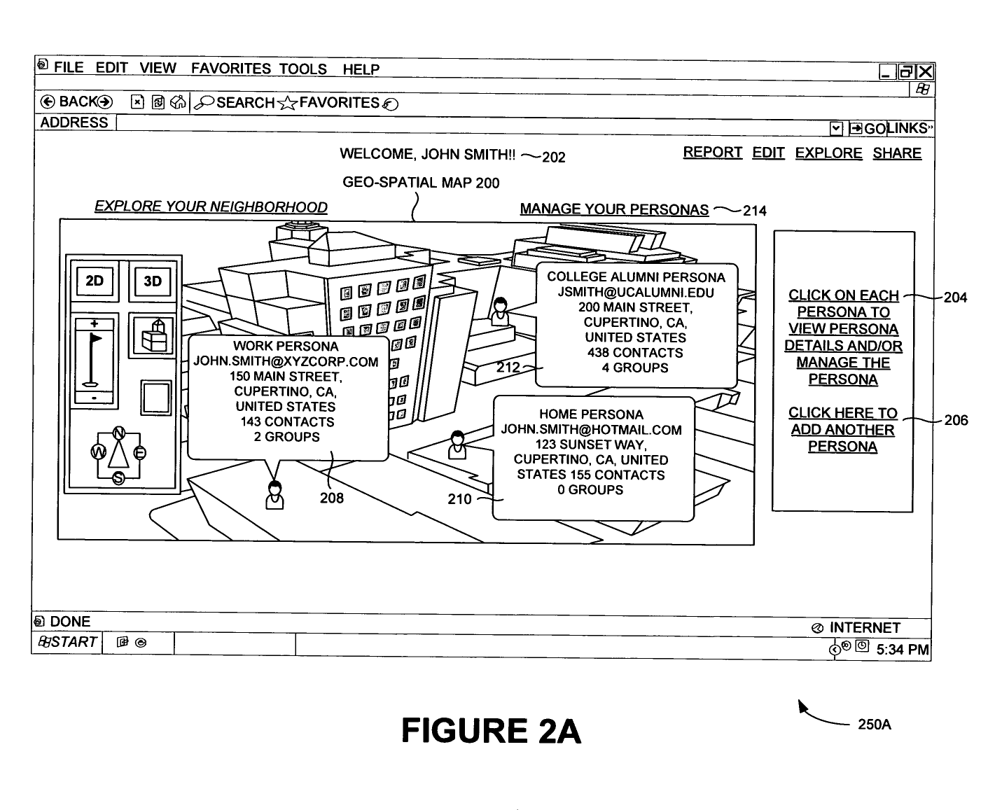

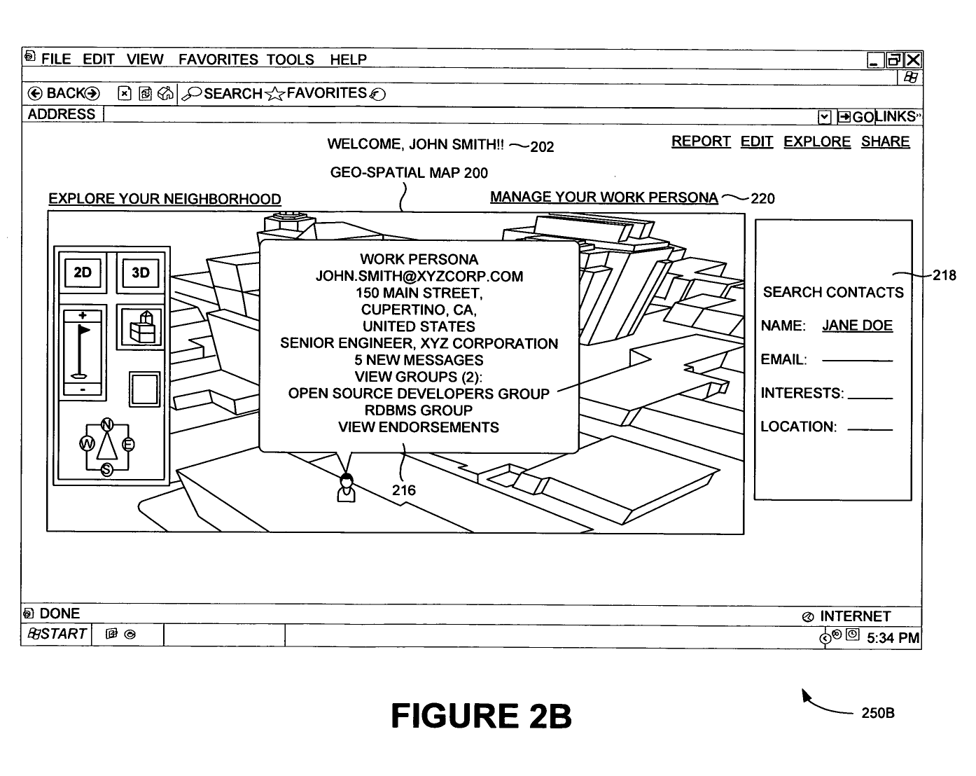

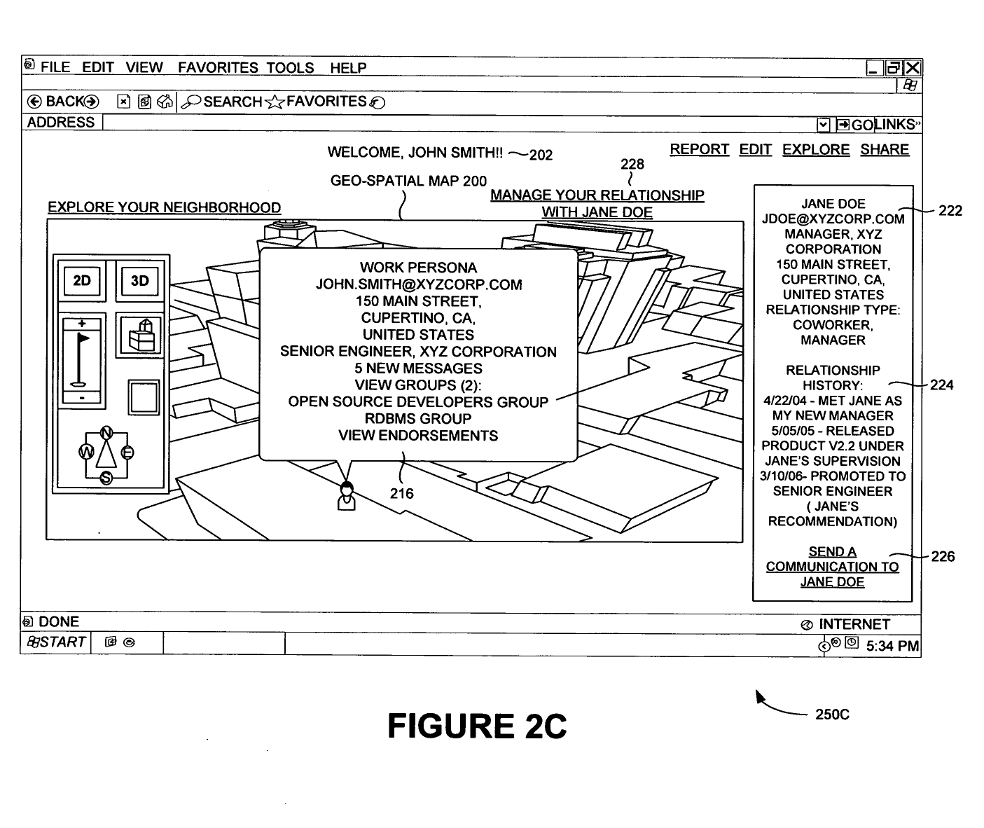

In one embodiment, a method of persona management includes creating a number of persona profiles (e.g., the persona profiles 208, 210 and 212 of FIG. 2A) associated with a first member (e.g., of the members 106A-N of FIG. 1) of a community network (e.g., the community network 102 of FIG. 1), determining a number of locations associated with each of the persona profiles 208, 210 and 212, displaying the persona profiles 210, 212 and 212 at the locations on a geo-spatial map (e.g., the geo-spatial map 200 of FIG. 2A), and managing the persona profiles 208, 210 and 212 using the geo-spatial map 200.

In another embodiment, a community network (e.g., the community network 102 of FIG. 1) includes a member repository (e.g., the member repository 116 of FIG. 1) including a number of members (e.g., the members 106A-N of FIG. 1), a geo-spatial repository (e.g., the geo-spatial repository 114 of FIG. 1) including a number of locations on a geo-spatial map (e.g., the geo-spatial map 200 of FIG. 2A-C), a member management module (e.g., the member management module 108 of FIG. 1) configured to obtain member data (e.g., may include one or more locations) associated with each of the members 106A-N, and a persona management module (e.g., the persona management module 112 of FIG. 1) configured to obtain a number of persona profiles (e.g., the persona profiles 208, 210 and 212 of FIG. 2A) associated with a first member 106, determine the locations associated with the persona profiles 208, 210 and 212, display the persona profiles 208, 210 and 212 at the locations on the geo-spatial map 200, and manage the persona profiles 208, 210 and 212 using the geo-spatial map 200.

In yet another embodiment, a method of persona management includes creating a persona profile (e.g., the work persona profile 216 of FIG. 2B) associated with a member (e.g., of the members 106A-N of FIG. 1) of a community network (e.g., the community network 102 of FIG. 1), obtaining a location associated with the persona profile 208, obtaining a contact associated with the persona profile 216, determining a context of expression corresponding to the persona profile 216, generating a communication between the member 106 and the contact 314 based on the context of expression, and sending the communication to the contact using the community network 102.

FIG. 1 is a system view of a community network 102 enabling persona management in a geo-spatial environment, according to one embodiment. Particularly, FIG. 1 illustrates the community network 102, a community 104, members 106A-N, a member management module 108, content modules 110A-N, a persona management module 112, a geo-spatial repository 114 and a member repository 116, according to one embodiment.

The community network 102 may be a network formed by an association of the members 106A-N having persona profiles (e.g., the work persona profile 208, the home persona profile 210, the college alumni persona profile 212 of FIG. 2A). In one example embodiment, one or more persona profiles may be associated with each member (e.g., of the members 106A-N of FIG. 1) of the community network 102.

The community network 102 may enable the members 106A-N of the community 104 to create persona profiles (e.g., the persona profiles 208, 210 and 212 of FIG. 2A) containing information such as a name, an email address, contact information (e.g., an address, and/or a mobile number, etc.), contacts, groups, endorsements and/or other events. For example, a member may create a home persona profile 210 associated with a specific location corresponding to his residence, a work persona profile 208 associated with a specific location corresponding to a business, etc.

The community 104 may refer to a group of members 106A-N residing in a region and are connected with each other through the community network 102. For example, the region may correspond to a street, a city, a county, a state, a country, etc. The members 106A-N may be individuals having persona profiles (e.g., the persona profiles 208, 210 and 212 of FIG. 2A) associated with physical locations in the community 104. In an alternate embodiment, the members 106A-N may reside in multiple regions (e.g., cities, states, and/or countries, etc.). The members 106A-N may be connected through the community network 102, accessible using a network (e.g., Internet).

The member management module 108 may obtain member data associated with the members 106A-N of the community network 102. For example, the member data may include a name, age, profession, location information (e.g., address data) and/or email address associated with the members 106A-N. The member data may be displayed in the persona profiles (e.g., the persona profiles 208, 210 and 212 of FIG. 2A) of the members 106A-N on a geo-spatial map (e.g., the geo-spatial map 200 of FIG. 2A).

The content modules 110A-N may convert data to information (e.g., behavior, preferences, and/or activities of a particular member 106) associated with the members 106A-N of the community network 102. The content modules 110A-N may be connected to the persona management module 112 to manage relationships between the particular member 106 and the other members 106A-N of the community network 102. For example, the persona management module 112 may be connected to the content modules 110A-N to retrieve content (e.g., member data) associated with the persona profiles (e.g., the persona profiles 208, 210 and 212 of FIG. 2A) of the members 106A-N. For example, the content modules 110A-N may include persona information associated with the member 106. In one embodiment, each persona profile is associated with each of the content modules 110A-N. For example, the content may be different for each persona profile.

The persona management module 112 may obtain persona profiles (e.g., the persona profiles 208, 210 and 212 of FIG. 2A) associated with a member 106 of the community network 102. For example, the persona profiles may be classified based on member's persona, character dealing with multiple social roles played in daily life, such as work persona, home persona, college persona, etc.

The persona management module 112 may determine locations (e.g., using the member repository 116 and the geo-spatial repository 114 of FIG. 1) associated with the each of the persona profiles of the member 106. In one example embodiment, the persona profiles may be displayed at associated locations on the geo-spatial map 200. For example, a work persona may be displayed (e.g., on the geo-spatial map 200 of FIG. 2A) at a location associated with member's place of work and a home persona may be displayed (e.g., on the geo-spatial map 200 of FIG. 2A) at a location associated with member's residence. In one embodiment, both the work persona and home persona are associated with the member 106.

The persona management module 112 may also manage the persona profiles 208, 210 and 212 associated with the member 106 using the geo-spatial repository 114. In one example embodiment, the persona management module 112 may enable access to a particular persona profile (e.g., the persona profile 216 of FIG. 2B). For example, the member 106 may access the particular persona profile 216 to view information such as contacts, groups, endorsements, and/or events, associated with the persona profile 216. Further, the persona management module 112 may determine a context of expression associated with the persona profile 216 of the member 106 of the community network 102. For example, the context of expression may be determined based on member's behavior, status, activities, and/or preferences associated with the persona profile 216.

In addition, the persona management module 112 may generate a communication between the persona profile 216 of the member 106 and a contact associated with the persona profile 216 based on the context of expression. In one example embodiment, the contact may be another member 106 of the community network 102 having persona profiles. In another example embodiment, the contact associated with the member 106 may not have persona management activated. The context of expression may be determined based on a relationship history between the member 106 and the contact. For example, the relationship history may include a personal relation, social relation, family relation, professional relation, informal relation, and/or formal relation, etc.

In one example embodiment, the communication may be generated based on the context of expression between the member 106 and the contact. In one example embodiment, the contact may be selected from a number of contacts using the search contacts option 218 (e.g., as illustrated in FIG. 2B). In addition, the communication may be sent (e.g., using the community network 102 of FIG. 1) to the contact via email, voice mail, phone, IM, text messages and/or postal mail.

The geo-spatial repository 114 may be a database including location information associated with the members 106A-N. Locations associated with the members 106A-N may be obtained based on the location information stored in the geo-spatial repository 114. The member repository 116 may be a database including member data associated with the members 106A-N of the community network 102 which assists the members 106A-N in managing their persona profiles (e.g., work persona profile, home persona profile, university persona profile, etc.).

In one embodiment, a number of persona profiles (e.g., the persona profiles 208, 210 and 212 of FIG. 2A) associated with a first member (e.g., of the members 106A-N of FIG. 1) of the community network 102 may be created (e.g., using the persona management module 112 of FIG. 1) and locations associated with the persona profiles (e.g., associated with an email address, contact, group, endorsements and/or event, etc.) may be obtained (e.g., using the geo-spatial repository 114 and the member repository 116 of FIG. 1). Further, the persona profiles may be displayed at the locations on a geo-spatial map 200. The persona profiles may be managed (e.g., through the persona management module 112 of FIG. 1) using the geo-spatial map 200.

In another embodiment, a persona profile (e.g., the persona profile 216 of FIG. 2B) may be accessed and a context of expression associated with the persona profile 216 may be determined (e.g., based on the first member's behavior, status, activities, and/or preferences in the persona profile). A communication may be generated between the persona profile 216 and a contact (e.g., may include a second member 106 of the community network 102) associated with the persona profile 216 based on the context of expression (e.g., determined based on a relationship history between the first member 106 and the contact). In addition, the communication may be sent (e.g., through an email address, phone, IM and/or physical mail) to the contact using the community network 102.

The member repository 116 may include the members 106A-N and the geo-spatial repository 114 may include the locations on the geo-spatial map 200. The member management module 108 may be configured to obtain member data (e.g., may include locations) associated with each of the members 106A-N. The persona management module 112 may be configured to obtain persona profiles (e.g., the persona profiles 208, 210 and 212 of FIG. 2A) associated with the first member, 106 determine the locations associated with the persona profiles 208, 210 and 212, display the persona profiles 208, 210 and 212 at the locations on the geo-spatial map 200 and manage the persona profiles 208, 210 and 212 using the geo-spatial map 200.

The persona management module 112 may further be configured to access a persona profile 216 (e.g., may be associated with an email address, contact, group, endorsement, and/or event), determine a context of expression associated with the persona profile (e.g., based on the first member's behavior, status, activities, and/or preferences, etc.), generate a communication between the persona profile 216 and the contact associated with the persona profile 216 based on the context of expression (e.g., determined based on a relationship history between the first member 106 and the contact), send the communication to the contact using the community network 102.

FIG. 2A is a user interface view 250A displaying persona profiles (e.g., the persona profiles 208, 210, and 212) associated with a member (e.g., of the members 106A-N of FIG. 1) on a geo-spatial map 200, according to one embodiment. Particularly, FIG. 2A illustrates the geo-spatial map 200, a welcome message 202, a click on each persona option 204, a click here to add another persona option 206, the persona profiles 208, 210, and 212 and a manage your personas option 214, according to one embodiment.

The geo-spatial map 200 may graphically display the persona profiles 208, 210 and 212 (e.g., may include member's work persona, home persona etc.) associated with the member 106 (e.g., owner of a webpage). For example, the persona profiles 208, 210 and 212 may include information, such as member's name, email id, address, number of new messages, contacts and/or groups associated with the member 106.

For example, member data (e.g., address, email address, etc.) associated with work persona (e.g., as illustrated in persona profile 208 of FIG. 2A) may be different from member data associated with home persona (e.g., as illustrated in persona profile 210 of FIG. 2A). Further, email address, contacts, endorsements and/or groups associated with the work persona profile 208 may be different from that of the home persona profile 210.

The welcome message 202 may display a unique identifier (e.g., first name, last name, code, etc.) of the user (e.g., the member 106) associated with the webpage. In other words, the welcome message 202 may be displayed to the user upon logging into the webpage. The click on each persona option 204 may enable the user to view information associated with a particular persona profile, to access the persona profile. The user may access the persona profile to view the information associated with each persona profile and/or edit content associated with the persona profile to update, modify and/or add new contacts, groups, endorsements and/or events in the persona profiles.

The click here to add another persona option 206 may enable the user to add a new persona profile associated with the user to the geo-spatial map 200. The user may create a new persona profile through the webpage based on anyone of activities, status, behavior, events which the user may perform in daily life that allows the user to further communicate with the other members of the community network 102. For example, if the user attends a university in a particular city, associating university persona with the city may help the user to remember a context of persona associated with the university persona.

The persona profiles 208, 210 and 212 may contain the information such as a name, email address, contact information (e.g., address, mobile number, etc.), contacts, groups, endorsements and/or other events, etc. The persona profiles 208, 210 and 212 may be associated with the user of the community network 102. The manage your personas option 214 may enable the user to manage the persona profiles 208, 210 and 212. In one embodiment, managing the persona profiles 208, 210 and 212 on the geo-spatial map 200 may include viewing each location on the geo-spatial map 200 and the persona profiles 208, 210 and 212 associated with the location. In addition, the location may add to a context of the persona.

In the example embodiment illustrated in FIG. 2A, the user interface view displays the welcome message 202 and the persona profiles 208, 210 and 212 on the geo-spatial map 200. The welcome message 202 displays “Welcome, John Smith” representing a webpage associated with John Smith. The persona profiles 208, 210 and 212 may represent a Work persona, a Home persona and a College Alumni persona respectively associated with John Smith. The persona profile 208 displays email address “john.smith@xyzcorp.com”, number of contacts “143”, and number of groups “2” associated with work persona. In one example embodiment, the work persona profile 208 may be displayed (e.g., on the geo-spatial map 200) at a location “150 Main Street, Cupertino, Calif., United States”. The work persona profile 208 may be associated with John Smith's work profile.

The persona profile 210 displays email address “john.smith@hotmail.com”, number of contacts “155”, and number of groups “0” associated with Home persona. In one example embodiment, the home persona profile 210 may be displayed (e.g., on the geo-spatial map 200) at a residence associated with the address “123 Sunset Way, Cupertino, Calif., United States”. The home persona profile 210 may be associated with John Smith's persona profile.

The persona profile 212 displays email address “jsmith@ucalumni.edu”, number of contacts “438”, and number of groups “4” associated with College Alumni persona. In one example embodiment, the college alumni persona profile 212 may be displayed (e.g., on the geo-spatial map 200) at a university/college address “200 Main Street, Cupertino, Calif., United States”. The college alumni persona profile 212 may be associated with John Smith's university profile.

As illustrated in FIG. 2A, the persona profiles 208, 210 and 212 associated with John Smith are displayed at respective locations corresponding to the persona (e.g., work persona, home persona, university persona etc.). John Smith may access the persona profiles to view and/or edit the persona profiles using the manage your personas option 214. In addition, John Smith may access each persona profile using the click on each persona option 204. John Smith may also create new persona profile(s) associated with an email address using click here to add another persona option 206. In one example embodiment, John Smith may be tied with other members 106A-N in the contact list of a particular persona profile (e.g., contacts associated with anyone of the work persona profile 208, the home persona profile 210, the college alumni profile 212) through an email address associated with the particular persona profile.

FIG. 2B is a user interface view 250B of managing a persona profile 216 using the geo-spatial map 200, according to one embodiment. Particularly, FIG. 2B illustrates the geo-spatial map 200, the welcome message 202, the persona profile 216, the search contacts option 218 and a manage your work persona option 220, according to one embodiment.

The persona profile 216 may provide information associated with the work persona, such as user's email id, location information, designation in a particular corporation, new messages, groups that the user may have participated in, and/or endorsements, etc. The search contacts option 218 may enable the user to search for other members 106A-N in contact list associated with persona profile 216. For example, the user may search for contacts in the contact list using name, email address, interest and/or location, etc.

The manage your work persona option 220 may enable the user to access the work persona profile 216 using the geo-spatial map 200. In one embodiment, managing the work persona profile 208 on the geo-spatial map 200 may include viewing each location on the geo-spatial map 200 and the work persona profile 208 associated with the location. The location may add to a context of the persona. For example, if John Smith serves XYZ Corporation at 150 Main ST., Cupertino, associating the work persona with 150 Main St., Cupertino may help John Smith memorize a context of the work persona. The user can view contacts, groups, and/or endorsements associated with the work persona profile 216. In one example embodiment, the user can add, update and/or delete contacts and/or groups associated with the work persona profile 216 through the manage your work persona option 220.

In the example embodiment illustrated in FIG. 2B, the user interface view 250B displays the welcome message 202 and the persona profile 216 (e.g., associated with the work persona) on the geo-spatial map 200. The welcome message 202 displays “Welcome John Smith” representing a webpage associated with John Smith. As illustrated in FIG. 2B, John Smith has selected (e.g., using the click on each persona option 204 as illustrated in FIG. 2A) the work persona to view details associated with the work persona and/or to manage the work persona.

The persona profile 216 displays an email address john.smith@xyzcorp.com and location information “150 Main Street, Cupertino, Calif., United States” (e.g., as illustrated in persona profile 208 of FIG. 2A). In addition, the persona profile 216 displays a designation of John Smith as “Senior Engineer” in “XYZ Corporation”. Also, the persona profile 216 displays John Smith has 5 unread messages and also names groups “Open Source Developers Group” and “RDBMS Group”.

John Smith may search for a contact(s) in contacts list using search contacts option 218. In one example embodiment, John Smith may search for a contact based on name, email address, interests, and/or location, etc. For example, John Smith may provide “Jane Doe” as a search query. As a result, information associated with the search query may be displayed on the geo-spatial map 200.

In one example embodiment, the search contacts option 218 may allow John Smith to easily search contacts (e.g., may be another member 106 of the community network 102) associated with the work persona and to communicate with the contact. Jane Doe (e.g., colleague of John Smith in XYZ Corporation) may not have persona management activated.

The manage your work persona option 220 may enable John Smith to supervise the work persona based on John Smith's daily life. For example, multitude of social roles (e.g., home persona, work persona, and/or college persona etc.) of John Smith may result in role confusion and also lead to misguided communication between John Smith and his contact (e.g., Jane Doe). In order to avoid complexity, the manage your work persona option 220 may obtain an accurate predefined role of John Smith in each persona profile.

FIG. 2C is a user interface view 250C of generating a communication between the persona profile 216 and the contact associated with the persona profile 216 based on a context of expression, according to one embodiment. Particularly, FIG. 2C illustrates the geo-spatial map 200, the welcome message 202, the persona profile 216, the contact's profile block 222, a relationship history block 224, a send a communication option 226 and a manage option 228, according to one embodiment.

The contact's profile block 222 may display information associated with the contact based on the search result (e.g., corresponding to the search query provided through the search contacts option 218). For example, the information may include contact's name, email id, address, and/or relationship status with respect to the user's persona profile 216. The relationship history block 224 may display the history of relations between the contact and the user's persona. For example, the relationship history may be associated with personal relationship, professional relationship, informal relationship, formal relationship, social relationship, and/or family relationship, etc.

The send a communication option 226 may enable the user to send a communication to the contact. The communication may be generated based on a type of relationship between the persona profile 216 and the contact associated with the persona profile 216. The communication may be sent to the contact through various methods such as email, voice mail, phone, IM, postal mail, and/or text message, etc.

In the example embodiment illustrated in FIG. 2, the user interface view 250C displays the persona profile 216 on the geo-spatial map 200. The user interface view 250C also displays profile information associated with the contact “Jane Doe” corresponding to the search query provided by John Smith (e.g., using the search contacts option 218 of FIG. 2B).

The contact's profile block 222 displays the name of the contact “Jane Doe” having an email address jdoe@xyzcorp.com. The contact's profile block 222 also displays designation of Jane Doe as “Manager” of “XYZ Corporation” located at “150 Main Street, Cupertino, Calif., United States”. The relationship between John Smith and Jane Doe may be professional relationship (e.g., John Smith is a coworker of Jane Doe).

In one embodiment, the relationship history between John Smith and Jane Doe is displayed in the relationship history block 224. The relationship history block 224 displays information that John Smith met Jane Doe as his new manager on 22 Apr. 2004, released product V2.2 under Jane's supervision on 5 May 2005 and was promoted as Senior Engineer on Jane's recommendation on 10 Mar. 2006. In addition, John Smith may send a communication (e.g., based on the relationship history as illustrated in the relationship history block 224) to Jane Doe using the send a communication option 226. For example, John Smith may send communication to Jane Doe through various methods such as email, voice mail, phone, IM, postal mail, and/or text message, etc.

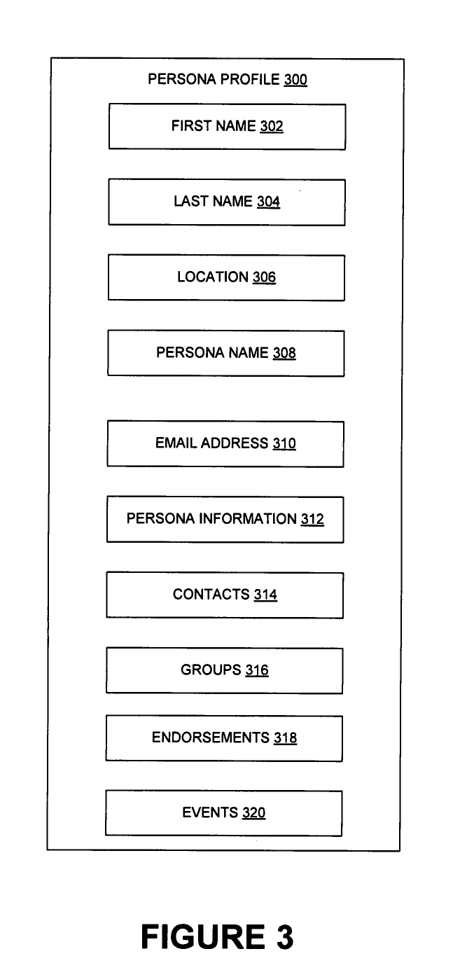

FIG. 3 is a block diagram illustrating persona profile details of a member 106 in the community network 102, according to one embodiment. Particularly, FIG. 3 illustrates a first name 302, a last name 304, a location 306, a persona name 308, an email address 310, a persona information 312, contacts 314, groups 316, endorsements 318 and events 320, according to one embodiment.

The persona profile 300 may include profile information associated with a persona of the member 106. The first name 302 may be a name (e.g., Bill, George, Hillary, etc.) given to a person which differentiates members 106A-N of a group of individuals, especially, within a family. The last name 304 may be an inherited name (e.g., Gates, Clinton, Williams, etc.) of the member 106. For example, children may inherit their family name and/or surname from their parents. The location 306 may be an area, city, county and/or locality (e.g., Palo Alto, Cupertino, etc.) in which the member 106 represented by the first name 302 resides.

The persona name 308 may be a unique identifier (e.g., Halloween, Tulip, Evening Star, etc.) associated with a persona of the member 106 of the community network 102. The email address 310 may be mode of communication (e.g., may be through an email) associated with the member 106 of the community network 102 used to send a communication to a contact (e.g., based on a context of expression).

The persona information 312 may be information associated with a persona (e.g., special interests, hobbies, etc.) of the member 106. The contacts 314 may be details associated with various contacts of the member 106. The groups 316 may be a list of groups and/or communities (e.g., foot-ball association, golf club, meditation group, etc.) to which the member 106 may be affiliated. The endorsements 318 may be a promotional statement associated with a particular service and/or product supported by the member 106 in the community network 102.

For example, the endorsement 318 may be categorized into political endorsement (e.g., republican, democratic, etc.), product endorsement (e.g., ambassador for Nike, L'Oreal, etc.) and/or service (e.g., McDonald, FedEx, etc.). The events 320 may be a noteworthy happening and/or a social occasion, an activity, etc. associated with the member 106. For example, the events 320 may be a festival, a ceremony, a competition, a party and/or a convention, etc.

In the example embodiment illustrated in FIG. 3, the block representation illustrates various details (e.g., name, address data, persona information, contacts, groups, endorsements, events, etc.) associated with the member 106. The persona profile 300 may be searched using these details on the geo-spatial map 200.

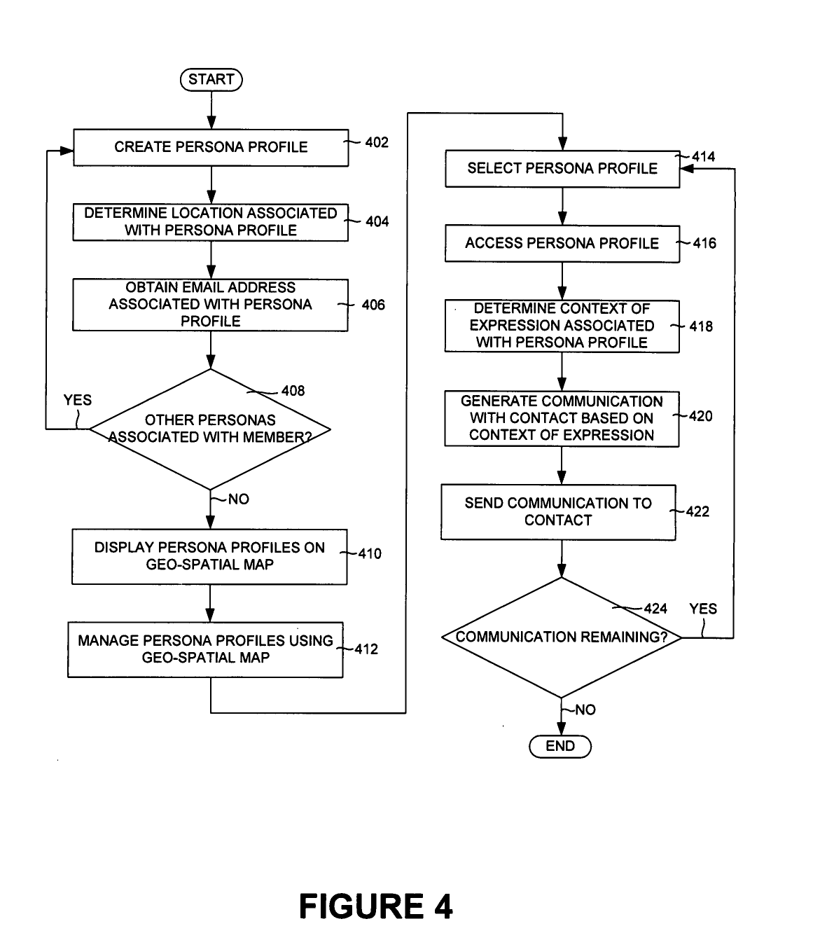

FIG. 4 is a flowchart of managing persona profiles of a member 106 and sending a communication, according to one embodiment. In operation 402, the persona profile 300 associated with a member 106 is created (e.g., using the persona management module 112 of FIG. 1). For example, the persona profile 300 may include a name (e.g., first name, last name), location, persona name, email address, persona information, contacts, groups, endorsements, and/or events, etc.

In operation 404, a location of the member 106 is determined (e.g., based on persona profile data). For example, different persona profiles (e.g., the persona profiles 208, 210 and 212 of FIG. 2A) of the member 106 may be associated with different locations. Alternatively, each persona profile of the member 106 may be associated with single or multiple locations. In operation 406, email address associated with the persona profile 300 of the member 106 is obtained (e.g., using member data of the member management module 108 of FIG. 1).

In operation 408, a check is performed on whether other personas are associated with the member 106 or not. If other personas associated the member 106 are determined then the process will return to operation 402 and will repeat the operations 402-408 else, in operation 410, persona profiles (e.g., the persona profiles 208, 210 and 212 of FIG. 2A) associated with the member 106 is displayed on geo-spatial map 200. In one example embodiment, the geo-spatial map 200 may be display different persona profiles such as the work persona profile 208, the home persona profile 210, and/or the college persona profile 212, etc. associated with the member 106 at specific locations.

In operation 412, persona profiles 208, 210 and 212 associated with the member 106 are managed (e.g., using persona management module 112 of FIG. 1) through the geo-spatial map 200. In one embodiment, managing the persona profiles 208, 210 and 212 on the geo-spatial map 200 may include viewing each location on the geo-spatial map 200 and the persona profiles 208, 210 and 212 associated with the location. The location may add to a context of the persona. For example, if John Smith attends university in Cupertino, associating the university persona with Cupertino may help John Smith remember the context of that persona. In operation 414, a persona profile (e.g., the work persona profile 216 as illustrated in FIG. 2B) associated with the member 106 is selected (e.g., through the click on each persona details and/or manage the persona option 204).

In operation 416, the persona profile 216 associated with the member 106 is accessed (e.g., through the geo-spatial map 200). For example, ways of accessing the persona profile 216 may include accessing the persona profile 216 directly on a back-end server, accessing database as XML format, etc. In operation 418, context of expression (e.g., academic, social, general, etc.) associated with persona profile 216 of the member 106 is determined (e.g., based on a relationship history of the member 106 associated with a contact). For example, the context of expression may be based on member's behavior, status, activities, and/or preferences in the persona profiles, etc. The relationship between the member 106 and the contact may be personal, social, family, professional, informal, and/or formal, etc.

In operation 420, communication with a contact is generated (e.g., using the send a communication option 226 of FIG. 2C) based on the context of expression (e.g., public, private, etc.). For example, the contact may include other member 106 associated with work persona, home persona, and/or college alumni persona, etc. of the member 106. In operation 422, the communication is sent to the contact (e.g., through online contact). The communication may be sent through email, IM, voice chat, and/or text message, etc. In operation 424, a determination is made whether any communication between the member 106 and the contact is remaining or not. If no more communication is to be made, then the process may terminate otherwise, process may go to the operation 414 and repeat the operations 416-423.

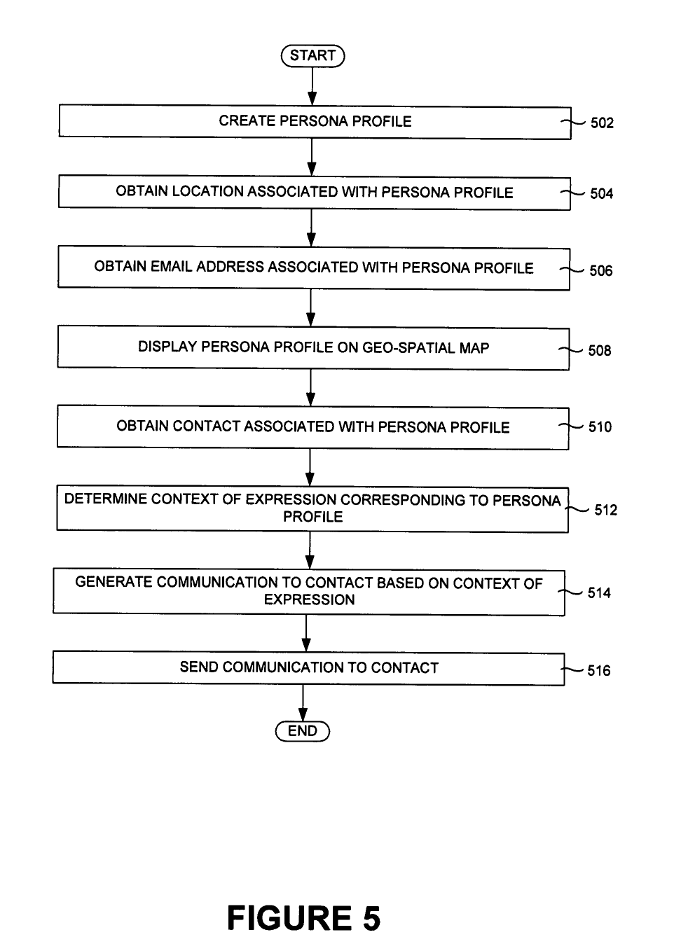

FIG. 5 is a flow chart of displaying persona profiles of a member 106 and sending a communication to a contact based on a context of expression, according to one embodiment. In operation 502, a persona profile 300 of a member 106 (e.g., the persona profile 300 of FIG. 3) in the community network 102 is created (e.g., using the persona management module 112 of FIG. 1). For example, the persona profile 300 may be related to member's work persona, home persona, and/or college persona, etc.

In operation 504, a location associated with the persona profile 300 is obtained (e.g., through the geo-spatial repository 114 and the member repository 116 of FIG. 1). In one example embodiment, different persona profiles (e.g., the persona profiles 208, 210 and 212 of FIG. 2A) of the member 106 may be associated with different locations. Alternatively, each persona profile of the member 106 may be associated with single or multiple locations. For example, the location may add to a context of the persona.

In operation 506, an email address associated with the persona profile 300 is obtained (e.g., using the member management module 108 of FIG. 1). In operation 508, the persona profile 300 is displayed on a geo-spatial map (e.g., the geo-spatial map 200 of FIG. 2A-C). In one example embodiment, the geo-spatial map 200 may be display different persona profiles such as the work persona profile 208, the home persona profile 210, and/or the college persona profile 212, etc. associated with the member 106 at specific locations.

In operation 510, the contact associated with the persona profile 300 is obtained (e.g., from the member 106). For example, the contact may include other members 106 associated with the work persona, the home persona, and/or the college alumni persona, etc. of the member 106. In one embodiment, the contact associated with the member 106 may not have persona management activated. In operation 512, the context of expression corresponding to the persona profile 300 is determined (e.g., based on a relationship history between the member 106 and the contact). For example, the context of expression may be based on a relationship history between the member 106 and the contact. The relationship between the member 106 and the contact may be personal, social, family, professional, informal, and/or formal, etc.

In operation 514, a communication to the contact is generated (e.g., using the persona management module 112 of FIG. 1) based on the context of expression. In operation 516, communication is sent to the contact. The communication to the contact may be sent through an email, voicemail, phone, IM, postal mail, and/or text message, etc.

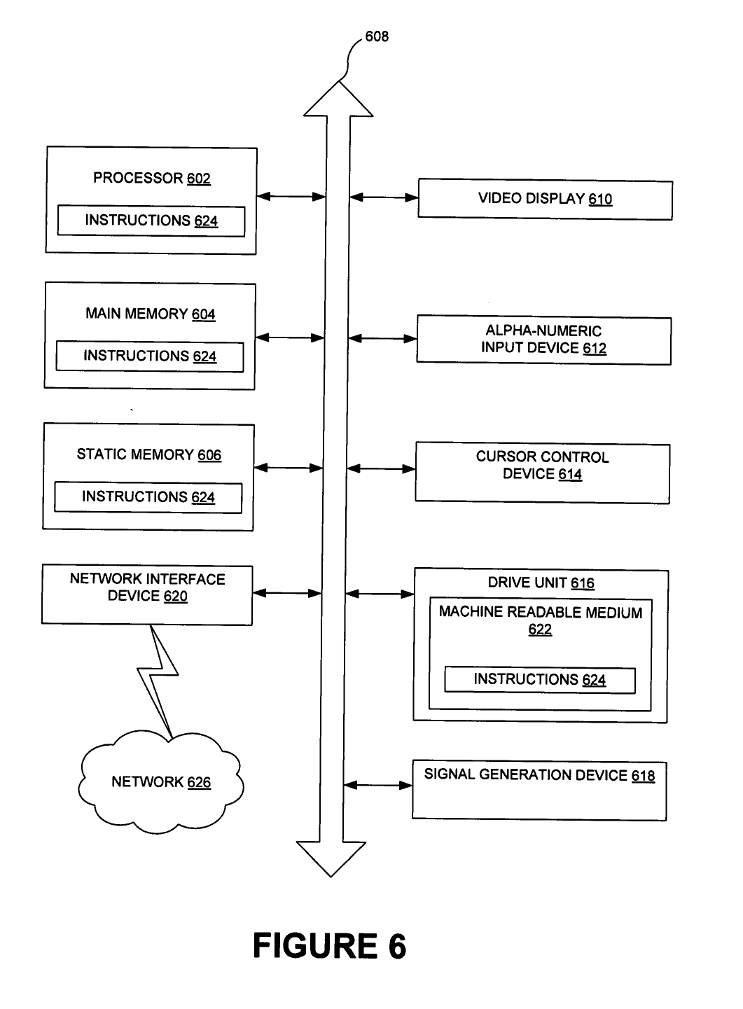

FIG. 6 is a diagrammatic system view 600 of a data processing system in which any of the embodiments disclosed herein may be performed, according to one embodiment. Particularly, the diagrammatic system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624 and a network 626, according to one embodiment.

The diagrammatic system view 600 may indicate a personal computer and/or a data processing system in which one or more operations disclosed herein may be performed. The processor 602 may be a microprocessor, a state machine, an application-specific integrated circuit, a field programmable gate array, etc. (e.g., Intel® Pentium® processor). The main memory 604 may be a dynamic random access memory and/or a primary memory of a computer system. The static memory 606 may be a hard drive, a flash drive, and/or other memory information associated with the data processing system. The bus 608 may be an interconnection between various circuits and/or structures of the data processing system.

The video display 610 may provide graphical representation of information on the data processing system. The alpha-numeric input device 612 may be a keypad, a keyboard and/or any other input device of text (e.g., a special device to aid the physically challenged). The cursor control device 614 may be a pointing device such as a mouse. The drive unit 616 may be the hard drive, a storage system, and/or other longer term storage subsystem. The signal generation device 618 may be a bios and/or a functional operating system of the data processing system.

The network interface device 620 may be a device that may perform interface functions such as code conversion, protocol conversion and/or buffering required for communication to and from a network. The machine readable medium 622 may provide instructions on which any of the methods disclosed herein may be performed. The instructions 624 may provide source code and/or data code to the processor 602 to enable any one or more operations disclosed herein.

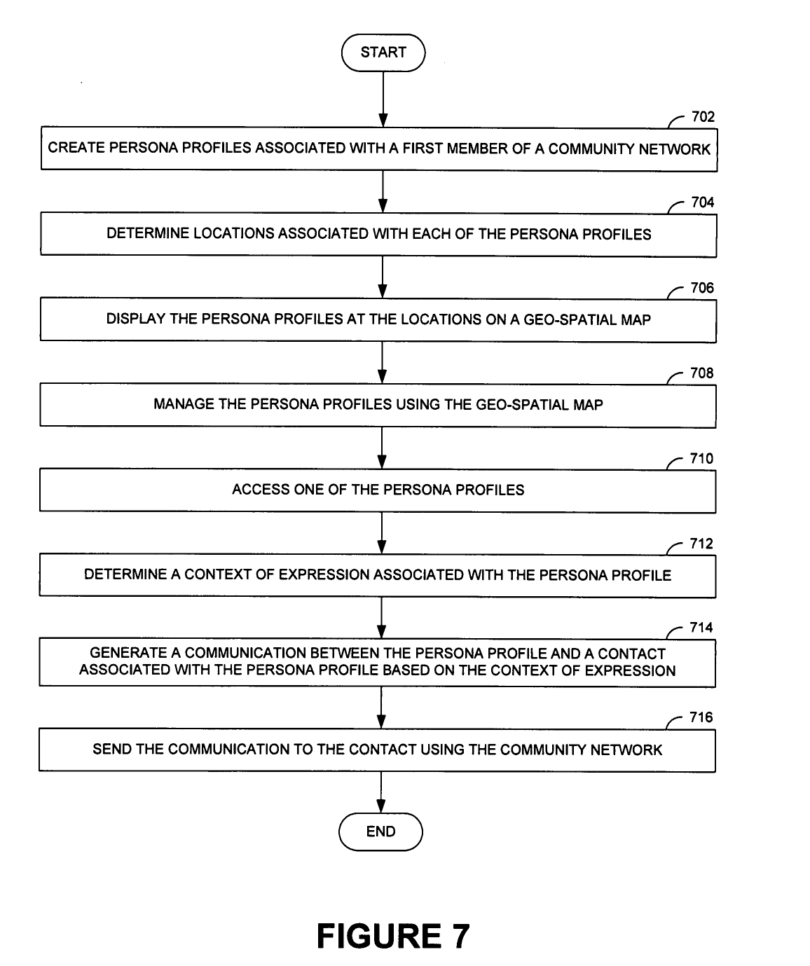

FIG. 7 is a process flow of managing persona profiles (e.g., the persona profiles 208, 210 and 212 of FIG. 2A) and sending a communication to a contact (e.g., using the second member 106) using the community network 102, according to one embodiment. In operation 702, persona profiles (e.g., the persona profiles 208, 210 and 212 of FIG. 2A) associated with a first member (e.g., of the members 106A-N of FIG. 1) of a community network 102 may be created (using the persona management module 112 of FIG. 1). In operation 704, locations associated with each of the persona profiles (e.g., the persona profiles 208, 210 and 212) may be determined (using the geo-spatial repository 114 and the member repository 116 of FIG. 1). In operation 706, the persona profiles 208, 210 and 212 may be displayed at the locations on a geo-spatial map (e.g., the geo-spatial map 200 of FIG. 2A-C). In operation 708, the persona profiles 208, 210 and 212 may be managed (e.g., through the persona management module 112 of FIG. 1) using the geo-spatial map 200.

In operation 710, one of the persona profiles (e.g., the work persona profile 208 of FIG. 2B) may be accessed (e.g., by the first member 106 through the geo-spatial map 200). In operation 712, a context of expression associated with the persona profile 208 may be determined (e.g., based on a relationship history between the first member 106 and the contact). In operation 714, a communication may be generated between the persona profile 208 (e.g., of the first member 106) and the contact associated with the persona profile 208 based on the context of expression (e.g., Jane Doe is connected to the first member 106 (John Smith) through John Smith's work persona profile 208, as illustrated in FIG. 2C). In operation 716, the communication may be sent (e.g., through email, voicemail, phone, IM, postal mail, and/or text message, etc.) to the contact using the community network 102.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the member management module 108, the persona management module 112 and other modules of FIGS. 1-8 may be enabled using a member management circuit, a persona management circuit and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of persona management, comprising:
creating a plurality of persona profiles associated with a first member of a community network;
determining a plurality of locations associated with each of the plurality of persona profiles;
displaying the plurality of persona profiles at the plurality of locations on a geo-spatial map; and
managing the plurality of persona profiles using the geo-spatial map.

2. The method of claim 1, further comprising:
accessing one of the plurality of persona profiles;
determining a context of expression associated with the one of the plurality of persona profiles;
generating a communication between the one of the plurality of persona profiles and a contact associated with the one of the plurality of persona profiles based on the context of expression; and
sending the communication to the contact using the community network.

3. The method of claim 2, wherein the context of expression is based on the first member's behavior, status, activities, and preferences in the one of the plurality of persona profiles.

4. The method of claim 2, wherein the context of expression is based on a relationship history between the first member and the contact.

5. The method of claim 2, wherein the contact comprises a second member of the community network.

6. The method of claim 1, wherein each of the plurality of persona profiles is associated with an email address.

7. The method of claim 1, wherein each of the plurality of persona profiles is associated with at least one of a contact, a group, an endorsement, and an event.

8. The method of claim 1 in a form of a machine-readable medium embodying a set of instructions that, when executed by a machine, causes the machine to perform the method of claim 1.

9. A community network, comprising:
a member repository comprising a plurality of members;
a geo-spatial repository comprising a plurality of locations on a geo-spatial map;
a member management module configured to obtain member data associated with each of the plurality of members, wherein the member data comprises at least one of the plurality of locations; and
a persona management module configured to:
obtain a plurality of persona profiles associated with a first of the plurality of members;
determine the at least one of the plurality of locations associated with the plurality of persona profiles;
display the plurality of persona profiles at the at least one of the plurality of locations on the geo-spatial map; and
manage the plurality of persona profiles using the geo-spatial map.

10. The community network of claim 9, wherein the persona management module is further configured to:
access one of the plurality of persona profiles;
determine a context of expression associated with the one of the plurality of persona profiles;
generate a communication between the one of the plurality of persona profiles and a contact associated with the one of the plurality of persona profiles based on the context of expression; and
send the communication to the contact using the community network.

11. The community network of claim 10, wherein the context of expression is based on the first of the plurality of members' behavior, status, activities, and preferences in the one of the plurality of persona profiles.

12. The community network of claim 10, wherein the context of expression is based on a relationship history between the first of the plurality of members and the contact.

13. The community network of claim 10, wherein the contact comprises a second of the plurality of members.

14. The community network of claim 9, wherein each of the plurality of persona profiles is associated with one of a plurality of content modules.

15. The community network of claim 9, wherein each of the plurality of persona profiles is associated with at least one of an email address, a contact, a group, an endorsement, and an event.

16. A method of persona management, comprising:
creating a persona profile associated with a member of a community network;
obtaining a location associated with the persona profile;
obtaining at least one contact associated with the persona profile;
determining a context of expression corresponding to the persona profile;
generating a communication between the member and the at least one contact based on the context of expression; and
sending the communication to the at least one contact using the community network.

17. The method of claim 16, further comprising:
displaying the persona profile on a geo-spatial map.

18. The method of claim 16, further comprising:
obtaining an email address associated with the persona profile.

19. The method of claim 16, wherein the context of expression is based on a relationship history between the member and the contact.

20. The method of claim 16, wherein the persona profile is associated with at least one of a contact, a group, an endorsement, and an event.
